(19) United States
(12) Patent Application Publication
(10) Pub. No.: US 2025/0378375 A1
(43) Pub. Date: Dec. 11, 2025

(54) SYSTEM AND METHOD FOR ESTABLISHING A SERVER NOISE PREDICTION MODEL

(71) Applicants: INVENTEC (PUDONG) TECHNOLOGY CORPORATION, Shanghai (CN); INVENTEC CORPORATION, Taipei City (TW)

(72) Inventors: Min Chen CHEN, Taipei City (TW); Tung-Lin TSAI, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/945,288

(22) Filed: Nov. 12, 2024

(30) Foreign Application Priority Data
Jun. 11, 2024 (CN) 202410750085.9

(51) Int. Cl. G06N 20/00

(52) U.S. Cl. CPC G06N 20/00

(57) ABSTRACT

A method for establishing a server noise prediction model includes: obtaining a plurality of raw data, wherein each raw data includes a plurality of fan configurations, a plurality of server configurations, and a plurality of actual noise values; dividing the plurality of raw data into a training dataset and a testing dataset; extracting at least one fan configuration and at least one server configuration from the training dataset to train a prediction model; inputting the testing dataset into the prediction model to generate a plurality of predicted noise values; calculating a model evaluation metric according to the plurality of predicted noise values and the plurality of actual noise values; outputting the prediction model when the model evaluation metric exceeds a threshold; and retraining the prediction model by changing the training configurations when the model evaluation metric does not exceed the threshold.

### CROSS-REFERENCE TO RELATED APPLICATIONS

This non-provisional application claims priority under 35 U.S.C. § 119 (a) on Patent Application No(s). 202410750085.9 filed in People Republic of China on Jun. 11, 2024, the entire contents of which are hereby incorporated by reference.

### BACKGROUND

### 1. Technical Field

This disclosure relates to server noise management, and more particularly, to a system and method for establishing a server noise prediction model.

### 2. Related Art

Currently, server noise management often relies on actual noise measurement tests.

However, this approach presents several issues. First, because actual noise measurement tests are conducted only after the server design is completed, noise problems can only be identified at a later stage, making it difficult to implement improvements early in the design process. At the same time, conducting actual noise measurement tests requires specialized equipment and resources, and multiple tests are typically needed to ensure accuracy, which increases project costs. Furthermore, performing actual noise measurement tests involves significant manual labor, including setting up the testing environment, executing tests, and analyzing data, thereby increasing the labor costs of the project.

### SUMMARY

Accordingly, this disclosure provides a system and method for establishing a server noise prediction model to address the issues present in current practices.

According to an embodiment of this disclosure, a method for establishing a server noise prediction model comprises: obtaining a plurality of raw data, wherein each of the plurality of raw data includes a plurality of fan configurations, a plurality of server configurations and a plurality of actual noise values; dividing the plurality of raw data into a training dataset and a testing dataset; extracting at least one of the plurality of fan configurations and at least one of the plurality of server configurations from the training dataset to train a prediction model; inputting the testing dataset into the prediction model to generate a plurality of predicted noise values; calculating a model evaluation metric based on the plurality of predicted noise values and the plurality of actual noise values; outputting the prediction model when the model evaluation metric is greater than a threshold; and modifying a training configuration to retrain the prediction model when the model evaluation metric is not greater than the threshold.

According to an embodiment of this disclosure, a system for establishing a server noise prediction model comprises a storage element and a processing element. The storage element is configured to store a plurality of raw data, wherein each of the plurality of raw data includes a plurality of fan configurations, a plurality of server configurations and a plurality of actual noise values. The processing element is electrically connected to the storage element. The processing element is configured to divide the plurality of raw data into a training dataset and a testing dataset, to extract at least one of the plurality of fan configurations and at least one of the plurality of server configurations from the training dataset to train a prediction model, to input the testing dataset into the prediction model to generate a plurality of predicted noise values, and to calculate a model evaluation metric based on the plurality of predicted noise values and the plurality of actual noise values, wherein the prediction model is output when the model evaluation metric is greater than a threshold, and a training configuration is modified to retrain the prediction model when the model evaluation metric is not greater than the threshold.

In view of the above description, the system and method for establishing a server noise prediction model proposed by the present disclosure may have the following advantages: First, by utilizing artificial intelligence technology, it is possible to predict noise in the early stages of server design, which helps customers and manufacturers understand noise levels during the design phase. Second, by predicting noise in advance, the quantity of actual noise measurement tests and labor required in the later stages may be reduced, thereby lowering the overall project cost. Finally, the prediction results may be used to optimize server design, including fan configurations, cooling structures, etc., to reduce noise levels and improve the acoustic performance of the server.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram illustrating the system for establishing a server noise prediction model according to an embodiment of the present disclosure; and

FIG. 2 is a flowchart illustrating the method for establishing a server noise prediction model according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

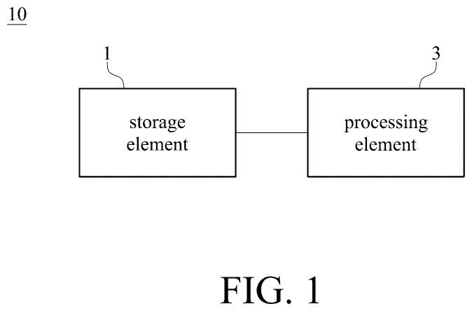

Please refer to FIG. 1, FIG. 1 is a block diagram illustrating the system for establishing a server noise prediction model according to an embodiment of the present disclosure. As shown in FIG. 1, the system 10 for establishing a server noise prediction model includes a storage element 1 and a processing element 3.

The storage element 1 is configured to store a plurality of raw data, wherein each of the raw data includes a plurality of fan configurations, a plurality of server configurations, and a plurality of actual noise values. In an embodiment, the plurality of fan configurations includes the quantity of fans, fan speed and fan power. In practice, noise data (including actual noise values or sound power levels) may be collected at different fan speeds through one or more sound sensors as the basis for establishing the prediction model. The plurality of server configurations includes the quantity of processors, the amount of memory, and chassis size.

In an embodiment, the storage element 1 may be implemented using at least one of the following examples: flash memory, a hard disk drive (HDD), a solid-state drive (SSD), dynamic random-access memory (DRAM), static random-access memory (SRAM), or other non-volatile memory. However, the present disclosure is not limited to the examples mentioned above.

The processing element 3 is electrically connected to the storage element 1. In an embodiment, the processing element 3 may be implemented using at least one of the following examples: a microcontroller (MCU), an application processor (AP), a field-programmable gate array (FPGA), an application-specific integrated circuit (ASIC), a system-on-a-chip (SOC), a deep learning accelerator, or any electronic device with similar functionality. However, the present disclosure is not limited to the examples mentioned above.

The processing element 3 is configured to divide the plurality of raw data into a training dataset and a testing dataset. In an embodiment, the processing element 3 assigns 80% of the raw data as the training dataset and the remaining 20% as the testing dataset, then extracting at least one fan configuration and at least one server configuration from the training dataset to train a prediction model. In an embodiment, the prediction model is a decision tree regression model. In other embodiments, the prediction model may utilize machine learning or deep learning techniques to predict the noise levels of the server under different configurations.

After the prediction model has been trained, the processing element 3 is configured to input the testing dataset into the prediction model to generate a plurality of predicted noise values, wherein the testing dataset includes a plurality of actual noise values. The processing element 3 calculates a model evaluation metric based on the plurality of predicted noise values and the plurality of actual noise values, wherein the prediction model is output when the model evaluation metric is greater than a threshold, and the training configuration is modified to retrain the prediction model when the model evaluation metric is not greater than the threshold. In an embodiment, the model evaluation metric is a coefficient of determination (R²), with the threshold set at 0.85. R²=1 indicates no error in the prediction model, R²≤0.8 indicates the prediction model is well-trained, and R²≤0 indicates a high error in the prediction model. In an embodiment, modifying the training configuration may include adjusting model parameters, changing the extracted features, increasing the quantity of raw data, etc.

In an embodiment, adjusting model parameters includes modifying the random state parameter in the model, such as changing the random state parameter from 0 to 42, thereby improving the coefficient of determination to greater than 0.85. In an embodiment, changing the extracted features includes adding different extracted features, such as fan manufacturer and/or fan size, and retraining the prediction model. In an embodiment, the data shows that increasing the quantity of raw data (for example, the quantity of raw data increased from 14 to 200) and then retraining the prediction model may enhance coverage, accuracy, and generalization ability, helping to resolve bias issues and improve understanding, performance, and ability to handle diverse tasks of the model.

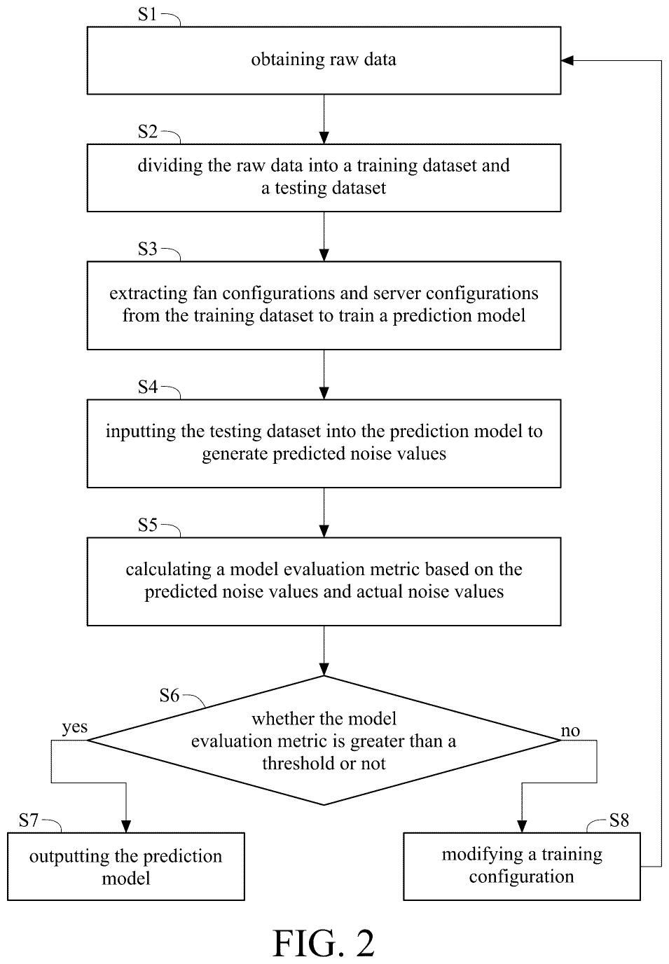

FIG. 2 is a flowchart illustrating the method for establishing a server noise prediction model according to an embodiment of the present disclosure. In an embodiment, the method may be executed through the system 10 for establishing a server noise prediction model, as shown in FIG. 1.

In step S1, the processing element 3 obtains a plurality of raw data from the storage element 1. Each of the raw data includes a plurality of fan configurations, a plurality of server configurations, and a plurality of actual noise values. The plurality of fan configurations includes at least one of the quantity of fans, fan speed and fan power. The plurality of server configurations includes at least one of the quantity of processors, the amount of memory and the chassis size.

In step S2, the processing element 3 divides the plurality of raw data into a training dataset and a testing dataset. In an embodiment, the training dataset accounts for 80%, and the testing dataset accounts for 20%.

In step S3, the processing element 3 extracts at least one fan configuration and at least one server configuration from the training dataset to train the prediction model. In an embodiment, the prediction model is, for example, a decision tree regression model.

In step S4, the processing element 3 inputs a plurality of testing data from the testing dataset into the prediction model to generate a plurality of predicted noise values, and different testing data have different fan configurations and server configurations.

In step S5, the processing element 3 calculates a model evaluation metric based on the plurality of predicted noise values and the plurality of actual noise values. In an embodiment, the model evaluation metric is, for example, the coefficient of determination R².

In step S6, the processing element 3 determines whether the model evaluation metric is greater than a threshold. In an embodiment, the threshold is set at 0.85. The larger the model evaluation metric, the closer the predicted results are to the actual results. When the determination in step S6 is “yes”, the process continues to step S7. When the determination in step S6 is “no”, the process continues to step S8.

In step S7, when the model evaluation metric is greater than the threshold, the processing element 3 outputs the prediction model.

In step S8, when the model evaluation metric is not greater than the threshold, the processing element 3 modifies the training configuration and returns to step S1 to retrain the prediction model. In an embodiment, modifying the training configuration may include adjusting model parameters, changing the extracted features, increasing the quantity of raw data, etc.

In an embodiment, after completing the training of the prediction model, a server configuration reference table may be established, for example, as shown in Table 1 below. The processing element 3 is further configured to query the server configuration reference table based on the server configuration and noise level requirements to adjust the server configuration. For example, when the noise level of a 2U server needs to be estimated and must meet a requirement of 85 decibels, the processing element 3 would automatically select a system configuration of 64.4 decibel fan unit noise, a fan speed of 17,700, and six fans based on the records in Table 1 below.

TABLE 1
server configuration reference table

| Fan Unit | Fan | Server | Number of | Predicted Noise |
|---|---|---|---|---|
| Noise | Speed | Size | Fans | Level |
| 64.4 | 17700 | 2 | 6 | 85 |
| 70 | 17500 | 2 | 6 | 84 |
| 69 | 20000 | 2 | 7 | 87 |
| 71 | 19700 | 2 | 6 | 83 |
| 70 | 18600 | 2 | 6 | 86 |
| 72 | 20500 | 2 | 6 | 88 |
| 69.5 | 20300 | 1 | 8 | 87 |
| 74.5 | 19300 | 1 | 8 | 87 |
| 69 | 19300 | 1 | 7 | 81 |
| 69 | 19300 | 1 | 7 | 82 |
| 75 | 19300 | 1 | 7 | 83 |
| 69 | 19680 | 1 | 8 | 81 |
| 60 | 4549 | 0 | 2 | 70 |
| 76.7 | 11500 | 0 | 2 | 92 |

In view of the above description, the system and method for establishing a server noise prediction model proposed by the present disclosure may have the following advantages: First, by utilizing artificial intelligence technology, it is possible to predict noise levels in the early stages of server design, which helps customers and manufacturers understand noise levels during the design phase. Second, by predicting noise in advance, the quantity of actual noise measurement tests and labor required in the later stages may be reduced, thereby lowering the overall project cost. Finally, the prediction results may be used to optimize server design, including fan configurations, cooling structures and so on, thereby reducing noise levels and improving the acoustic performance of the server.

In an embodiment of the present disclosure, the system and method for establishing a server noise prediction model may be applied to servers used for artificial intelligence (AI) computing, edge computing, as well as 5G servers, cloud servers, or Internet of Vehicles (IoV) servers.

What is claimed is:

1. A method for establishing a server noise prediction model, comprising:
obtaining a plurality of raw data, wherein each of the plurality of raw data includes a plurality of fan configurations, a plurality of server configurations and a plurality of actual noise values;
dividing the plurality of raw data into a training dataset and a testing dataset;
extracting at least one of the plurality of fan configurations and at least one of the plurality of server configurations from the training dataset to train a prediction model;
inputting the testing dataset into the prediction model to generate a plurality of predicted noise values;
calculating a model evaluation metric based on the plurality of predicted noise values and the plurality of actual noise values;
outputting the prediction model when the model evaluation metric is greater than a threshold; and
modifying a training configuration to retrain the prediction model when the model evaluation metric is not greater than the threshold.

2. The method according to claim 1, wherein the plurality of fan configurations includes at least one of a quantity of fans, fan speed and fan power, and the plurality of server configurations includes at least one of a quantity of processors, an amount of memory and chassis size.

3. The method according to claim 1, wherein the prediction model is a decision tree regression model.

4. The method according to claim 1, wherein the model evaluation metric is a coefficient of determination.

5. The method according to claim 1, wherein the threshold is 0.85.

6. A system for establishing a server noise prediction model, comprising:
a storage element configured to store a plurality of raw data, wherein each of the plurality of raw data includes a plurality of fan configurations, a plurality of server configurations and a plurality of actual noise values; and
a processing element electrically connected to the storage element, configured to divide the plurality of raw data into a training dataset and a testing dataset, extract at least one of the plurality of fan configurations and at least one of the plurality of server configurations from the training dataset to train a prediction model, input the testing dataset into the prediction model to generate a plurality of predicted noise values, and calculate a model evaluation metric based on the plurality of predicted noise values and the plurality of actual noise values, wherein the prediction model is output when the model evaluation metric is greater than a threshold, and a training configuration is modified to retrain the prediction model when the model evaluation metric is not greater than the threshold.

7. The system according to claim 6, wherein the plurality of fan configurations includes at least one of a quantity of fans, fan speed and fan power, and the plurality of server configurations includes at least one of a quantity of processors, an amount of memory and chassis size.

8. The system according to claim 6, wherein the prediction model is a decision tree regression model.

9. The system according to claim 6, wherein the model evaluation metric is a coefficient of determination.

10. The system according to claim 6, wherein the threshold is 0.85.
